(19) United States
(12) Patent Application Publication
(10) Pub. No.: US 2024/0222814 A1
(43) Pub. Date: Jul. 4, 2024

(54) ELECTROCHEMICAL APPARATUS, MODULE AND ELECTRONIC DEVICE

(71) Applicant: Ningde Amperex Technology Limited, Ningde (CN)

(72) Inventors: Qiao ZENG, Ningde (CN); Hongzhan YANG, Ningde (CN); Yong LI, Ningde (CN)

(73) Assignee: Ningde Amperex Technology Limited, Ningde (CN)

(21) Appl. No.: 18/399,727

(22) Filed: Dec. 29, 2023

(30) Foreign Application Priority Data
Dec. 30, 2022 (CN) 202211739741.2

(51) Int. Cl. H01M 50/538; H01M 50/536

(52) U.S. Cl. CPC H01M 50/538; H01M 50/536

(57) ABSTRACT

An electrochemical apparatus including a housing, an electrode assembly provided in the housing, and a first conductive plate. The electrode assembly includes a first electrode plate including a first area and a second area stacked in a first direction. A first electrode tab and a second electrode tab are respectively connected to the first area and the second area. The first conductive plate is electrically connected to the first electrode tab and the second electrode tab. The first electrode tab includes a first connection area including a first end connected to the first area and a second connection area. The first direction has a first side from the second area to the first area and a second side from the first area to the second area. The first connection area extends from the first end to the first side and is provided obliquely relative to the first direction.

### CROSS-REFERENCE TO RELATED APPLICATION

This application claims priority to the Chinese patent application No. 202211739741.2, filed on Dec. 30, 2022, the content of which is incorporated herein by reference in its entirety.

### TECHNICAL FIELD

This application relates to the field of energy storage, in particular to an electrochemical apparatus, a module with the electrochemical apparatus, and an electronic device.

### BACKGROUND

With the popularization of consumer electronic products such as laptops, mobile phones, handheld game consoles, tablet computers, mobile power supplies and drones, people's requirements on electrochemical apparatuses (such as lithium-ion batteries) are becoming increasingly strict.

An electrochemical apparatus typically includes a plurality of electrode tabs connected to electrode plates and a conductive plate connected the electrode tabs. The conductive plate protrudes from a housing to connect external devices. However, the electrode tabs may occupy a larger space in the housing, thus reducing the energy density of the electrochemical apparatus. Moreover, when mechanical abuse occurs in the electrochemical apparatus, the electrode tabs may pull the conductive plate. If the electrode tabs are separated from the conductive plate, it will reduce the reliability of the electrochemical apparatus.

### SUMMARY

In view of the above shortcomings, it is necessary to provide an electrochemical apparatus that is conducive to improving energy density and use reliability.

In addition, this application further provides a module with the electrochemical apparatus, and an electronic device.

In a first aspect, this application provides an electrochemical apparatus, including a housing, an electrode assembly provided in the housing, and a first conductive plate, the electrode assembly including a first electrode plate, the first electrode plate including a first area and a second area stacked in a first direction, wherein the electrochemical apparatus further includes a first electrode tab connected to the first area and a second electrode tab connected to the second area, the first conductive plate is electrically connected to the first electrode tab and the second electrode tab, and the first conductive plate protrudes from the housing; the first electrode tab includes a first connection area and a second connection area, the first connection area includes a first end connected to the first area, the first direction has a first side from the second area to the first area and a second side from the first area to the second area, the first connection area extends from the first end to the first side, the first connection area is provided obliquely relative to the first direction, the second connection area includes a second end connected to the first connection area, and the second connection area extends from the second end to the second side; in a second direction perpendicular to the first direction, the second end is provided apart from the electrode assembly.

In this application, the first electrode tab is bent, which is conducive to reducing the space of the head of the electrode assembly occupied by the first electrode tab in the second direction and improving the energy density of the electrochemical apparatus. Moreover, since the first connection area of the first electrode tab extends from the first end beyond the electrode assembly, in a case that the electrode assembly is caused to move in the housing and then pull the first electrode tab when mechanical abuse occurs in the electrochemical apparatus, the first connection area can provide a larger buffer space, thus reducing the pulling effect of the first electrode tab on the first conductive plate, reducing the possibility that the output voltage of the electrochemical apparatus is decreased and even it is impossible to continuously charge and discharge since the first electrode tab and the second electrode tab are separated from the first conductive plate, and also reducing the possibility of liquid leakage caused by the first conductive plate being pulled apart from the housing. Therefore, this application can improve the reliability and service life of the electrochemical apparatus.

In some possible examples, the second electrode tab includes a third connection area and a fourth connection area, the third connection area includes a third end connected to the second area, the third connection area extends from the third end to the first side, the third connection area is provided obliquely relative to the first direction, the fourth connection area includes a fourth end connected to the third connection area, the fourth connection area extends from the fourth end to the second side, and the second connection area and the fourth connection area are connected in a stacking manner. Since the third conductive area of the second electrode tab is provided obliquely relative to the first direction, in a case that the electrode assembly is caused to move in the housing and then pull the second electrode tab when mechanical abuse occurs in the electrochemical apparatus, the third connection area can provide a larger buffer space, thus reducing the pulling effect of the second electrode tab on the first conductive plate, reducing the possibility that the output voltage of the electrochemical apparatus is decreased and even it is impossible to continuously charge and discharge since the first electrode tab and the second electrode tab are separated from the first conductive plate, and also reducing the possibility of liquid leakage caused by the first conductive plate being pulled apart from the housing.

In some possible examples, at least the first electrode tab and the second electrode tab are welded to form a first electrode tab group, and the first electrode tab is located at the outermost layer of the first electrode tab group. In this way, the first connection area can provide a large buffer space, thus reducing the pulling effect of the first electrode tab on the first conductive plate, reducing the size of the portion of the entire first electrode tab group that goes beyond the electrode assembly from the first side, and reducing the influence on the energy density of the electrochemical apparatus in the first direction.

In some possible examples, the second electrode tab is located at the innermost layer of the first electrode tab group.

In some possible examples, the first conductive plate includes a first conductive area and a second conductive area connected to each other, the first conductive area is connected to the second connection area, the first conductive area includes a fifth end located at the first side and a sixth end located at the second side, the second conductive area is connected to the fifth end and extends in a direction away from the electrode assembly, and the second conductive area protrudes from the inside of the housing. At this time, a welding mark between the first conductive area and the second connection area protrudes towards the direction of the electrode assembly, which is conducive to reducing the possibility of the welding mark puncturing the housing and causing damage and liquid leakage to the housing.

In some possible examples, the first conductive plate includes a first conductive area and a second conductive area connected to each other, the first conductive area is connected to the fourth connection area, the first conductive area includes a fifth end located at the first side and a sixth end located at the second side, the second conductive area is connected to the sixth end and extends in a direction away from the electrode assembly, and the second conductive area protrudes from the inside of the housing. This application can reduce the impact of the sixth end on the end of the electrode plate when mechanical abuse occurs in the electrochemical apparatus, thus reducing the possibility of the active material on the electrode plate falling off and causing short-circuiting.

In some possible examples, the second end is located at the first side relative to the fifth end. In this way, when mechanical abuse occurs in the electrochemical apparatus, the area of the first electrode tab located between the first end and an intersection point (by drawing a straight line parallel to the second direction through the fifth end, an intersection point will exist between this straight line and the second connection area) can alleviate the pulling effect on the fifth end, thus reducing the possibility that the output voltage of the electrochemical apparatus is reduced and even it is impossible to continuously charge and discharge since the first electrode tab and the second electrode tab are separated from the first conductive plate, and also reducing the possibility of liquid leakage caused by the first conductive plate being pulled apart from the housing.

In some possible examples, when viewed from the second direction, the fifth end overlaps the electrode assembly. Therefore, when mechanical abuse occurs in the electrochemical apparatus, it can reduce the possibility of the fifth end impacting the housing, thus reducing the possibility of causing damage and liquid leakage to the housing.

In some possible examples, when viewed from the second direction, the sixth end overlaps the electrode assembly. Therefore, when mechanical abuse occurs in the electrochemical apparatus, it can reduce the possibility of the sixth end impacting the housing, thus reducing the possibility of causing damage and liquid leakage to the housing.

In some possible examples, when viewed from the first direction, the second end overlaps the second conductive area and the fifth end overlaps the second connection area. In this way, it is conducive to reducing the overall space occupied by the first electrode tab group and the second conductive area in the second direction, i.e., saving the space at the head of the electrode assembly, thus improving energy density.

In some possible examples, the second connection area and the first conductive area are provided obliquely relative to the first direction, and in the second direction, the sixth end is closer to the electrode assembly than the fifth end. This is conducive to further reducing the space occupied by the first electrode tab at the head of the electrode assembly in the second direction, and improving the energy density of the electrochemical apparatus.

In some possible examples, the electrochemical apparatus further includes a first layer containing an insulating material, and the first layer continuously covers a portion of the second conductive area, a portion of the second connection area and a portion of the first connection area. The first layer is used for covering burrs on the edges of the first conductive plate and the first electrode tab, so as to reduce the possibility of the burrs puncturing the housing and causing damage and liquid leakage to the housing.

In some possible examples, the electrochemical apparatus further includes a second layer containing an insulating material, and the second layer continuously covers a portion of the second conductive area, a portion of the first conductive area, a portion of the fourth connection area and a portion of the third connection area. The second layer is used for covering burrs on the edges of the first conductive plate and the second electrode tab, and can also cover the welding mark between the first conductive plate and the second electrode tab, so as to reduce the possibility of the burrs and welding marks puncturing the housing and causing damage and liquid leakage to the housing. The second layer covers the sixth end of the first conductive area, and can also reduce the impact of the sixth end on the end of the electrode plate when mechanical abuse occurs in the electrochemical apparatus, thus reducing the possibility of the active material on the electrode plate falling off and causing short-circuiting.

In some possible examples, the electrode assembly further includes a second electrode plate and a separator, and the first electrode plate, the separator and the second electrode plate are sequentially stacked and wound to form the electrode assembly.

In some possible examples, the electrode assembly has a winding central axis, a plane passing through the winding central axis and perpendicular to the first direction is defined as a winding central plane, and the first area and the second area are respectively located at two sides of the winding central plane. At this time, the electrode tabs in the first electrode tab group can be respectively connected to the first electrode plates on the two sides of the winding central axis. At this time, the number of the electrode tabs in the first electrode tab group can be increased according to actual needs. This is conducive to further reducing the internal resistance of the first electrode plate and improving the charge and discharge rate of the electrochemical apparatus.

In some possible examples, the electrode assembly has a winding central axis, a plane passing through the winding central axis and perpendicular to the first direction is defined as a winding central plane, and the first area and the second area are located at the same side of the winding central plane. At this moment, the electrode tabs in the first electrode tab group can be connected to the first electrodes located at the same side of the winding central plane. This is conducive to reducing the risk of causing the bending and the welding processes difficult due to the increase of the number of the electrode tabs of the first electrode tab group for the reason of considering the safety at the same time.

In some possible examples, the separator is located on at least a portion of the outermost layer of the electrode assembly. The separator can form a protective layer to avoid the risk of short-circuiting caused by the wear of the electrode plate on the inner side of the separator, thus increasing the resistance of the electrode assembly to mechanical impact.

In some possible examples, the housing includes a main body for accommodating the electrode assembly and a sealing portion connected to the main body, and the first conductive plate extends from the sealing portion to the housing; the main body includes a first end surface connected to the sealing portion, the first end surface includes a first surface extending from the sealing portion to the first side and a second surface extending from the sealing portion to the second side, and in the first direction, the width of the first surface is less than the width of the second surface; when viewed from the second direction, the second surface overlaps the first conductive area. Since the width of the space between the second side and the electrode assembly that accommodates the first conductive area in the first direction is large, it is conducive to reducing the possibility of the sixth end puncturing the housing and causing damage and liquid leakage to the housing when mechanical abuse occurs in the electrochemical apparatus.

In some possible examples, the housing includes a main body for accommodating the electrode assembly and a sealing portion connected to the main body, and the first conductive plate extends from the sealing portion to the housing; the main body includes a first end surface connected to the sealing portion, and the first end surface extends from the sealing portion to the second side; when viewed from the second direction, the first end surface overlaps the first conductive area. Since the width of the space between the first end surface and the electrode assembly that accommodates the first conductive area in the first direction is large, it is conducive to reducing the possibility of the sixth end puncturing the housing and causing damage and liquid leakage to the housing.

In some possible examples, the housing includes a first housing and a second housing provided opposite to each other in the first direction, the first housing includes a first polymer layer, the second housing includes a second polymer layer, and the first polymer layer and the second polymer layer are bonded to each other to form the sealing portion, so as to realize sealing. Moreover, the first polymer layer and the second polymer layer can also reduce the possibility of the housing being dissolved or swollen by organic solvents in the electrolyte.

In some possible examples, the first conductive plate is welded to the first electrode tab or the second electrode tab, so as to improve the strength of connection between the first conductive plate and the first electrode tab or the second electrode tab.

In a second aspect, this application further provides a module, including a casing and a plurality of electrochemical apparatuses described above, the plurality of electrochemical apparatuses being provided in the casing. By connecting a plurality of electrochemical apparatuses to form a module, the power supply voltage of the module can be improved, and the module has high reliability and long service life.

In a third aspect, this application further provides an electronic device, including the electrochemical apparatus or the module described above. The electronic device is supplied with power through the electrochemical apparatus described above and has high reliability and long service life.

### BRIEF DESCRIPTION OF DRAWINGS

The above and/or additional aspects and advantages of this application will become apparent and easy to understand from the description of the examples with reference to the drawings.

FIG. 1 illustrates a structural schematic diagram of an electrochemical apparatus when viewed from a first direction according to an example of this application.

FIG. 2A illustrates a sectional view of an electrode assembly of the electrochemical apparatus illustrated in FIG. 1 in some examples.

FIG. 2B illustrates a sectional view of an electrode assembly of the electrochemical apparatus illustrated in FIG. 1 in some other examples.

FIG. 3 illustrates a structural schematic diagram of the electrochemical apparatus illustrated in FIG. 1 before encapsulation in some examples.

FIG. 4 illustrates a structural schematic diagram of the electrochemical apparatus illustrated in FIG. 1 before encapsulation in some other examples.

FIG. 5A illustrates a sectional view of a first housing of a housing of the electrochemical apparatus illustrated in FIG. 1.

FIG. 5B illustrates a sectional view of a second housing of a housing of the electrochemical apparatus illustrated in FIG. 1.

FIG. 6 illustrates a sectional view of the electrochemical apparatus illustrated in FIG. 1 along VI-VI.

FIG. 7 illustrates an internal structural schematic diagram of the electrochemical apparatus illustrated in FIG. 1 when viewed from the first direction.

FIG. 8 illustrates a sectional view of the electrochemical apparatus illustrated in FIG. 1 in some other examples.

FIG. 9 illustrates a sectional view of an electrode assembly of the electrochemical apparatus illustrated in FIG. 1 in some other examples.

FIG. 10 illustrates a sectional view of an electrochemical apparatus according to another example of this application.

FIG. 11 illustrates a 3D diagram of a module according to an example of this application.

FIG. 12 illustrates an exploded diagram of the module illustrated in FIG. 11.

FIG. 13 illustrates a structural schematic diagram of an electronic device according to an example of this application.

This application will be further described below through the following specific examples with reference to the drawings.

### DETAILED DESCRIPTION

The technical solutions in the examples of this application will be clearly described below in detail. Apparently, the described examples are a part of the examples of this application, rather than all of them. Unless otherwise defined, all technical and scientific terms used herein have the same meanings as those commonly understood by technical personnel in the technical field of this application. The terms used in the description of this application are only for the purpose of describing the specific examples and are not intended to limit this application.

The examples of this application will be described below in detail. However, this application may be embodied in many different forms and should not be interpreted as limited to preferred examples described herein. Instead, providing these preferred examples enables this application to be conveyed to those skilled in the art thoroughly and in detail.

In addition, for simplicity and clarity, the dimensions or thicknesses of various components and layers may be enlarged in the drawings. Throughout the entire text, the same numerical values refer to the same elements. As used herein, the terms “and/or” and “or/and” include any and all combinations of one or more related listed items. In addition, it should be understood that when element A is referred to as “connected to” element B, element A may be directly connected to element B, or there may be intermediate element C, and element A and element B may be indirectly connected to each other.

Further, when describing the examples of this application, the term ‘may’ refers to “one or more examples of this application”.

The professional terms used herein are for the purpose of describing the specific examples and are not intended to limit this application. As used herein, the singular form is intended to also include the plural form, unless the context explicitly indicates otherwise. It should be further understood that the term “including”, when used in the description, refers to the existence of described features, numerical values, steps, operations, elements, and/or components, but does not exclude the existence or addition of one or more other features, numerical values, steps, operations, elements, components, and/or combinations thereof.

Spatial related terms, such as ‘on’, may be used herein for convenience in describing the relationship between one element or feature as illustrated in the figure and another element (a plurality of elements) or feature (a plurality of features). It should be understood that in addition to the directions described in the figures, spatial related terms are intended to include different directions of equipment or devices in use or operation. For example, if the device in the figure is flipped, elements described as “above” or “on” other elements or features will be oriented “below” or “under” other elements or features. Therefore, the exemplary term “on” may include directions “above” and “below”. It should be understood that although the terms first, second, third and the like may be used herein to describe various elements, components, areas, layers, and/or parts, these elements, components, areas, layers, and/or parts should not be limited by these terms. These terms are intended to distinguish one element, component, area, layer or part from another element, component, area, layer or part. Therefore, the first element, component, area, layer or part discussed below may be referred to as the second element, component, area, layer or part, without departing from the teachings of preferred examples.

In this application, if the parameter values are more than, less than, or not equal to the design relationship, it is necessary to exclude reasonable errors in the measurement equipment.

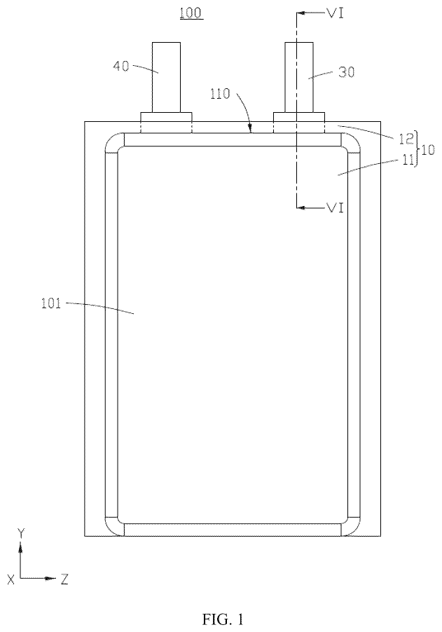

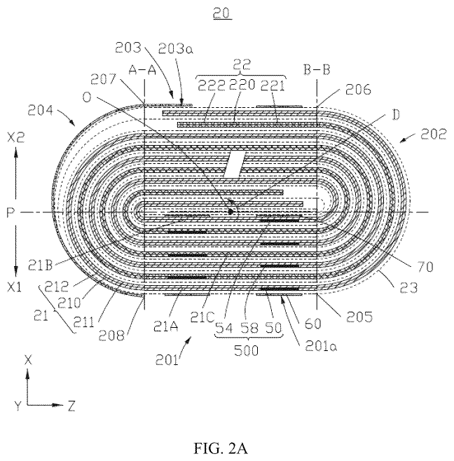

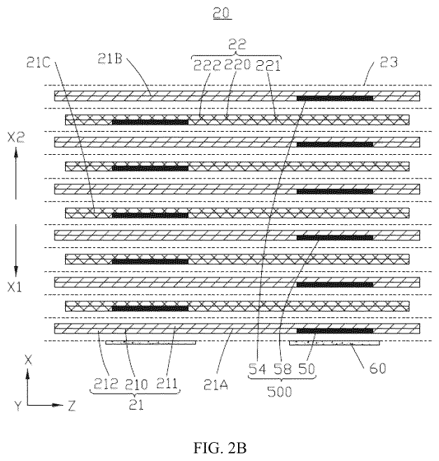

Please refer to FIG. 1 and FIG. 2A. An example of this application provides an electrochemical apparatus 100, which includes a housing 10, an electrode assembly 20 provided in the housing 10, a first conductive plate 30 and a second conductive plate 40. The electrode assembly 20 is in a wound or laminated structure, which includes a first electrode plate 21, a second electrode plate 22 and a separator 23 provided between the first electrode plate 21 and the second electrode plate 22. The separator 23 is used for preventing direct contact between the first electrode plate 21 and the second electrode plate 22, thus reducing the possibility of short-circuiting of contact between the first electrode plate 21 and the second electrode plate 22. The first conductive plate 30 is electrically connected to the first electrode plate 21, and the second conductive plate 40 is electrically connected to the second electrode plate 22. The first conductive plate 30 and the second conductive plate 40 extend from one end of the housing 10 to connect an external device (not shown). Referring to FIG. 2A, in some examples, the electrode assembly 20 is in a wound structure. The first electrode plate 21, the separator 23 and the second electrode plate 22 are sequentially stacked and wound to form the electrode assembly 20. The electrode assembly 20 has a winding direction D and a winding central axis O perpendicular to the paper surface. In some examples, after winding, the separator 23 is located at least a portion of the outermost layer of the electrode assembly 20. For example, the separator 23 is located at the outermost layer of the electrode assembly 20. The separator 23 can form a protective layer to avoid the risk of short-circuiting caused by wear of the electrode plate on an inner side of the separator 23, thus increasing the resistance of the electrode assembly 20 to mechanical impact. In other examples, the first electrode plate 21 or the second electrode plate 22 are located at the outermost layer of the electrode assembly 20. The winding direction D refers to a direction that a certain point of the first electrode plate 21, the separator 23 or the second electrode plate 22 illustrated in FIG. 2A moves from the inside to the outside around the winding central axis O. There are two types of winding directions D, namely clockwise or counterclockwise rotation direction around the winding central axis O. In some examples, the winding direction D is the counterclockwise rotation direction around the winding central axis O as illustrated in FIG. 2A. In the winding direction D, the electrode assembly 20 includes a first section 201, a first bent section 202, a second section 203 and a second bent section 204 that are sequentially connected. The first section 201 and the second section 203 may be flat and straight sections. In other examples, in the winding direction D, the electrode assembly 20 may also include four bent sections connected sequentially.

The first section 201 has a first outer surface 201a, and the second section 203 has a second outer surface 203a. A connection position between the first section 201 located at the outermost side of the electrode assembly 20 and the first bent section 202 located at the outermost side of the electrode assembly 20 is a first connection end 205. The first connection end 205 is a starting portion of a rightmost bent edge of the first bent section 202 in the winding direction D in FIG. 2A. The first connection end 205 is also a portion where a dashed line B-B formed by the extension of a right bent edge on the innermost portion of the electrode assembly 10 in a fifth direction Z′ intersects with the first outer surface 201a. A connection position between the first bent section 202 located at the outermost side of the electrode assembly 20 and the second section 203 located at the outermost side of the electrode assembly 20 is a second connection end 206. The second connection end 206 is an ending portion of the rightmost bent edge of the first bent section 202 in the winding direction D in FIG. 2A. The second connection end 206 is also a portion where the dashed line B-B formed by the extension of the right bent edge on the innermost portion of the electrode assembly 10 in the fifth direction Z′ intersects with the second outer surface 203a. A connection position between the second section 203 located at the outermost side of the electrode assembly 20 and the second bent section 204 located at the outermost side of the electrode assembly 20 is a third connection end 207. The third connection end 207 is a starting portion of a leftmost curve of the second bent section 204 in the winding direction D in FIG. 2A. The third connection end 207 is also a portion where a dashed line A-A formed by the extension of a left bent edge on the innermost portion of the electrode assembly 10 in the fifth direction Z′ intersects with the second outer surface 203a. A connection position between the second bent section 204 located at the outermost side of the electrode assembly 20 and the first section 201 located at the outermost side of the electrode assembly 20 is a fourth connection end 208. The fourth connection end 208 is an ending portion of a leftmost curve of the second bent section 204 in the winding direction D in FIG. 2A. The fourth connection end 208 is also a portion where the dashed line A-A formed by the extension of the left bent edge on the innermost portion of the electrode assembly 10 in the fifth direction Z′ intersects with the first outer surface 201a. In the fifth direction Z′, the first connection end 205 and the second connection end 206 are aligned, and the third connection end 207 and the fourth connection end 208 are aligned.

Please refer to FIG. 1 and FIG. 2A. A 3D coordinate system is established based on a first direction X, a second direction Y and a third direction Z which are perpendicular to one another. In this application, the first direction X is a direction perpendicular to a surface of the first conductive plate 30 located outside the housing 10, and is also a stacking direction of the first electrode plate 21 in the first section 201 or the second section 203. The first direction X has a first side X1 and a second side X2 opposite to the first side X1. The second direction Y is a direction in which the first conductive plate 30 or the second conductive plate 40 protrudes from the electrode assembly 20. When the electrode assembly 20 is in a wound structure, the second direction Y is also a direction of the winding central axis O of the electrode assembly 20. The third direction Z is a direction from the second conductive plate 40 to the first conductive plate 30.

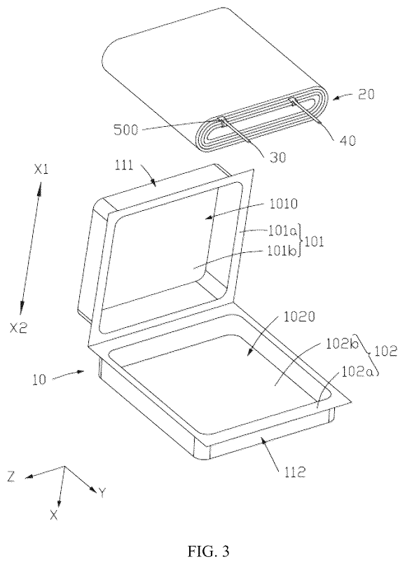

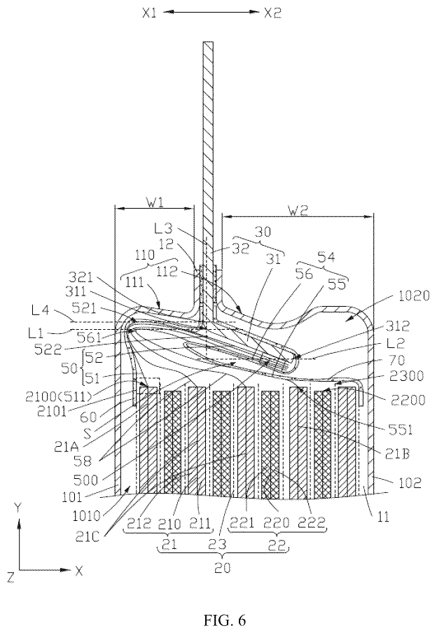

In some examples, the housing 10 may be a packaging bag obtained by encapsulating with an encapsulating film, and the electrochemical apparatus 100 may be a flexible battery. Referring to FIG. 1, the housing 10 includes a main body 11 for accommodating the electrode assembly 20 and a sealing portion 12 connected to the main body 11. The first conductive plate 30 and the second conductive plate 40 extend out of the housing 10 from the sealing portion 12. The first conductive plate 30 and the second conductive plate 40 can extend from the sealing portion 12 in the second direction Y. The main body 11 includes a first end surface 110 connected to the sealing portion 12. Please also refer to FIG. 6. In some examples, the first end surface 110 includes a first surface 111 extending from the sealing portion 12 to the first side X1 and a second surface 112 extending from the sealing portion 12 to the second side X2. The sealing portion 12 is located at a connection position between the first surface 111 and the second surface 112 in the first direction X. In the first direction X, the width W1 of the first surface 111 is less than the width W2 of the second surface 112. FIG. 3 illustrates a structural schematic diagram of the electrochemical apparatus 100 before encapsulation. FIG. 6 illustrates a sectional view of the housing 10 illustrated in FIG. 3 after encapsulation when viewed from the third direction Z. Referring to FIG. 3, the housing 10 includes a first housing 101 and a second housing 102 provided opposite to each other in the first direction X. The first housing 101 includes a first housing area 101a and a second housing area 101b connected to each other. Three sides of the second housing area 101b are surrounded by the first housing area 101a. The second housing 102 includes a third housing area 102a and a fourth housing area 102b connected to each other. Three sides of the fourth housing area 102b are surrounded by the third housing area 102a. The housing 10 is formed by encapsulating the first housing 101 and the second housing 102. The second housing area 101b of the first housing 101 is provided with a first concave portion 1010. The fourth housing area 102b of the second housing 102 is provided with a second concave portion 1020. The depth of the first concave portion 1010 is less than the depth of the second concave portion 1020. In this way, after the first housing 101 and the second housing 102 are encapsulated, the second housing area 101b and the fourth housing area 102b jointly form the main body 11 for accommodating the electrode assembly 20. The first housing area 101a is connected to the third housing area 102a to seal the main body 11. The sealing portion 12 is the first housing area 101a and the third housing area 102a that are partially connected. At this time, the side wall of the first concave portion 1010 connected to the sealing portion 12 is the first surface 111, and the side wall of the second concave portion 1020 connected to the sealing portion 12 is the second surface 112.

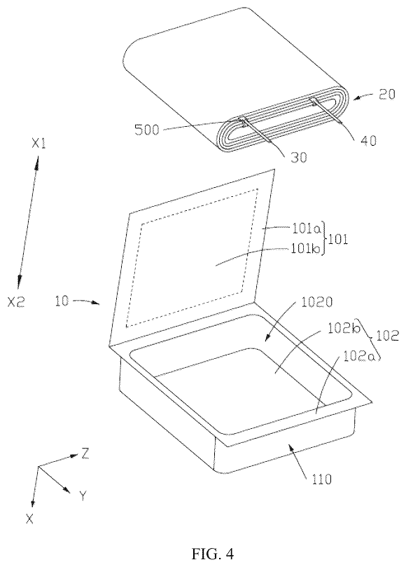

Please refer to FIG. 4. In other examples, the first housing 101 may also be in a flat plate structure. After the first housing 101 and the second housing 102 are encapsulated, the second concave portion 1020 is sealed by the second housing area 101b of the first housing 101 to form the main body 11. At this time, it can be understood that the side wall of the second concave portion 1020 connected to the sealing portion 12 is the first end surface 110. The first end surface 110 extends from the sealing portion 12 to the second side X2.

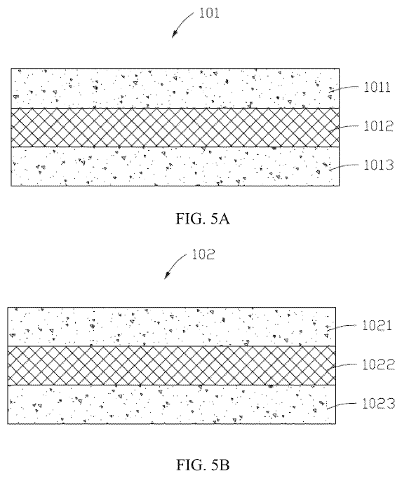

In some examples, the materials of the first housing 101 and the second housing 102 may be multilayer sheets. Referring to FIG. 5A, the first housing 101 may include a first protective layer 1011, a first metal layer 1012 and a first polymer layer 1013 stacked sequentially. The first polymer layer 1013 is closer to the electrode assembly 20 than the first protective layer 1011. The material of the first protective layer 1011 may be polymer resin, which can be used for protecting the first metal layer 1012, reduce the possibility of damage to the first metal layer 1012 due to external force, and simultaneously delay air infiltration from the external environment to maintain a normal operating environment inside the electrochemical apparatus 100. In some examples, the material of the first protective layer 1011 may be at least one selected from the group consisting of ethylene terephthalate, polybutylene terephthalate, polyvinylidene fluoride, polytetrafluoroethylene, polypropylene, polyamide and polyimide. The first metal layer 1012 can be used for delaying water infiltration into the external environment and reducing damage caused by external force to the electrode assembly 20. In some examples, the first metal layer 1012 may be an aluminum foil layer or a steel foil layer. The first polymer layer 1013 has the property of melting under heating, which can be used for sealing and can reduce the possibility of multilayer sheets being dissolved or swollen by organic solvents in the electrolyte. The first polymer layer 1013 can also be used for reducing the possibility of causing the metal layer to be corroded due to the contact between the electrolyte and the first metal layer 1012. In some examples, the first polymer layer 1013 includes a polymer material, which may be at least one selected from the group consisting of polypropylene, propylene copolymer, polyethylene, and polymethyl methacrylate. Referring to FIG. 5B, the second housing 102 may include a second protective layer 1021, a second metal layer 1022 and a second polymer layer 1023 stacked sequentially. It can be understood that in a case that the first housing 101 and the second housing 102 can be obtained by folding an encapsulating film, the materials of the second protective layer 1021, the second metal layer 1022 and the second polymer layer 1023 are completely the same as those of the first protective layer 1011, the first metal layer 1012 and the first polymer layer 1013, respectively, which will not be repeated here. When the housing 10 is fabricated, certain temperature and pressure may be applied simultaneously at the first housing area 101a and the third housing area 102a using a sealing head of an encapsulating device, to make the first polymer layer 1013 and the second polymer layer 1023 melt and bond together, thus forming the sealing portion 12.

In other examples, the housing 10 may also be a metal housing, such as a steel housing or an aluminum housing.

Referring to FIG. 2A and FIG. 6, the first electrode plate 21 includes a first active material layer 211, a first current collector 210 and a second active material layer 212 stacked sequentially. The first active material layer 211 is closer to the winding central axis O than the second active material layer 212. The first electrode plate 21 may be a positive electrode plate or a negative electrode plate. Correspondingly, the first current collector 210 can be a positive electrode current collector or a negative electrode current collector. Both the first active material layer 211 and the second active material layer 212 may be positive electrode active material layers or negative electrode active material layers. The second electrode plate 22 includes a third active material layer 221, a second current collector 220 and a fourth active material layer 222 stacked sequentially. The third active material layer 221 is closer to the winding central axis O than the fourth active material layer 222. The second electrode plate 22 may be a negative electrode plate or a positive electrode plate. Correspondingly, the second current collector 220 may be a negative electrode current collector or a positive electrode current collector. Both the third active material layer 221 and the fourth active material layer 222 may be negative electrode active material layers or positive electrode active material layers. In some examples, the first electrode plate 21 is a negative electrode plate, and the second electrode plate 22 is a positive electrode plate.

The positive electrode current collector may be an aluminum foil or a nickel foil, while the negative electrode current collector may be at least one of a copper foil, a nickel foil and a carbon-based current collector.

The positive electrode active material layer contains a positive electrode active material. The positive electrode active material includes a compound that can reversibly intercalate and de-intercalate lithium-ions (lithium intercalation compound). In some examples, the positive electrode active material may include a lithium transition metal composite oxide. The lithium transition metal composite oxide contains lithium and at least one element selected from the group consisting of cobalt, manganese and nickel. In some examples, the positive electrode active material is at least one selected from the group consisting of lithium cobalate (LiCoO₂), lithium nickel manganese cobalt ternary material (NCM), lithium manganate (LiMn₂O₄), lithium nickel manganate (LiNi_{0.5}Mn_{1.5}O₄) and lithium iron phosphate (LiFePO₄).

The negative electrode active material layer contains a negative electrode active material, which is a known negative electrode active material capable of reversibly de-intercalating active ions in the art, which is not limited in this application. For example, it may be, including but not limited to, one or a combination of more of graphite, soft carbon, hard carbon, carbon fiber, mesophase carbon microsphere, silicon-based material, tin-based material, lithium titanate and other metals that can form alloys with lithium. Graphite may be one or a combination of more selected from the group consisting of artificial graphite, natural graphite and modified graphite. The silicon-based material may be one or a combination of more selected from the group consisting of elemental silicon, silicon oxide compound, silicon carbon composite and silicon alloy; The tin-based material may be one or a combination of more selected from the group consisting of elemental tin, tin oxide compound, tin alloy, etc.

The separator 23 includes at least one of polyethylene, polypropylene, polyvinylidene fluoride, polyethylene terephthalate, polyimide and aramid. For example, polyethylene includes at least one selected from the group consisting of high-density polyethylene, low-density polyethylene and ultra-high molecular weight polyethylene. Polyethylene and polypropylene have a good effect on improving short-circuiting and can improve the stability of the electrochemical apparatus 100 through a turn-off effect.

Referring to FIG. 2A and FIG. 6, the first electrode plate 21 includes a first area 21A and a second area 21B stacked in the first direction X. In the first direction X, from the second area 21B to the first area 21A is the first side X1, and from the first area 21A to the second area 21B is the second side X2. For example, in a case that the electrode assembly 20 is in a wound structure, the electrode assembly 20 includes a first electrode plate 21. After being wound, the first electrode plate 21 forms a plurality of first electrode plates 21 stacked along the first direction X in both the first section 201 and the third section 203 (a layer of first current collector 210 and a first active material layer 211 and a second active material layer 212 provided on the surface of the first current collector 210 are defined as a layer of first electrode plate 21). At this time, the first area 21A and the second area 21B are two layers of first electrode plates 21 stacked in the first section 201 and/or the third section 203. Referring to FIG. 2B, in a case that the electrode assembly 20 is in a laminated structure, the electrode assembly 20 includes a plurality of first electrode plates 21 stacked in the first direction X. The first area 21A and the second area 21B are two of the first electrode plates 21 stacked in the first direction X. For simplicity, FIG. 2A and FIG. 2B may only exemplarily illustrate a portion of the first electrode plate 21 in the electrode assembly 20, omitting another portion of the first electrode plate 21. Therefore, it can be understood that the actual number of layers of the first electrode plates 21 is not limited to that illustrated the figures. Referring to FIG. 6, in order to reduce the possibility of lithium precipitation in the negative electrode plate, in the second direction Y, an end 2100 of the first electrode plate 21 extends beyond an end 2200 of the second electrode plate 22. In the second direction Y, an area that the first electrode plate 21 goes beyond the second electrode plate 22 is an extended area 2101. Further, in order to fully avoid direct contact between the first electrode plate 21 and the second electrode plate 22, in the second direction Y, an end 2300 of the separator 23 extends beyond the end 2100 of the first electrode plate 21.

The electrochemical apparatus 100 further includes a first electrode tab 50 connected to the first area 21A and a second electrode tab 54 connected to the second area 21B. The first electrode tab 50 extends from the first area 21A to the first end surface 110 in the second direction Y, but the first electrode tab 50 may extend to a position not in contact with the first end surface 110. The second electrode tab 54 extends from the second area 21B to the first end surface 110 in the second direction Y, but the second electrode tab 54 may extend to a position not in contact with the first end surface 110. The first electrode tab 50 and the second electrode tab 54 have the same polarity. In some examples, the first electrode tab 50 may be integrally molded with the first current collector 210 in the first area 21A and extend out of the first current collector 210. The second electrode tab 54 may be integrally molded with the first current collector 210 in the second area 21B and extend out of the first current collector 210. For example, the first electrode tab 50 and the second electrode tab 54 may be respectively formed by cutting the first current collector 210. In other examples, the first electrode tab 50 may also be welded to the surface of the first current collector 210 in the first area 21A, and the second electrode tab 54 may also be welded to the surface of the first current collector 210 in the second area 21B. The first conductive plate 30 is electrically connected to the first electrode tab 50 and the second electrode tab 54, and protrudes from the housing 10. In some specific examples, the first conductive plate 30 is connected to the first electrode tab 50. Since the first electrode tab 50 and the second electrode tab 54 are simultaneously provided on the first electrode plate 21, the current distribution of the first electrode plate 21 will not be too concentrated, thus reducing the internal resistance of the first electrode plate 21, and improving the charge and discharge rate of the first electrode plate 21. It can be understood that FIG. 2A only illustrates the end connected to the electrode plate in each electrode tab, but does not illustrate other areas of the electrode tab, so as to more clearly illustrate the position of the electrode plate connected to each electrode tab in the electrode assembly 20.

Referring to FIG. 6, in some examples, at least the first electrode tab 50 and the second electrode tab 54 are stacked and welded together to form a first electrode tab group 500. The first electrode tab group 500 is located between the electrode assembly 20 and the first end surface 110 in the second direction Y. The first electrode tab group 500 is bent, so that the first electrode tab group 500 can form a roughly U-shaped structure. Specifically, the first electrode tab 50 and the second electrode tab 54 are respectively bent to form a roughly U-shaped structure. Since the first electrode tab group 500 is bent to form a roughly U-shaped structure, the first electrode tab group 500 will form a hollow internal space S. At this time, the first electrode tab group 500 has an outermost layer and an innermost layer. The outermost layer of the first electrode tab group 500 refers to the electrode tab of the first electrode tab group 500 connected to the first conductive plate 30, while the innermost layer of the first electrode tab group 500 refers to the electrode tab of the first electrode tab group 500 farthest from the first conductive plate 30 along the stacking direction. The first electrode tab 50 may be located at the outermost layer of the first electrode tab group 500. The first conductive plate 30 is connected to the first electrode tab 50. In some examples, the first conductive plate 30 is welded to the first electrode tab 50, so as to improve the strength of connection between the first conductive plate 30 and the first electrode tab 50.

Further, the second electrode tab 54 may be located at the innermost layer of the first electrode tab group 500. The first electrode tab group 500 may also include at least one third electrode tab 58 sandwiched between the first electrode tab 50 and the second electrode tab 54, so as to further reduce the internal resistance of the first electrode plate 21 and improve the charge and discharge rate of the first electrode plate 21. Further, the first polar plate 21 may further include at least one third area 21C provided between the first area 21A and the second area 21B in the first direction X. The third electrode tab 58 is connected to the third area 21C. The first electrode tab 50, the second electrode tab 54 and the third electrode tab 58 are welded together to form the first electrode tab group 500.

Referring to FIG. 2A, a plane passing through the winding central axis O and perpendicular to the first direction X is defined as a winding central plane P. In this application, the winding central plane P is a virtual plane that passes through the entire electrode assembly 20 in the third direction Z. The winding central plane P is only used for dividing the structure of the electrode assembly 20 located at two sides of the virtual plane, which does not mean that the electrode assembly 20 located at the two sides of the winding central plane P must be strictly symmetrical relative to the winding central plane P. In some examples, the first area 21A and the second area 21B are located at the same side of the winding central plane P in the first direction X. Therefore, in a case that the first electrode tab 50 and the second electrode tab 54 are respectively located at the outermost layer and the innermost layer of the first electrode tab group 500, it means that all electrode tabs in the first electrode tab group 500 are connected to the first electrode plate 21 located at the same side of the winding central plane P. For example, the number of the electrode tabs in the first electrode tab group 500 may be the same as the number of the electrochemical apparatuses 100 with a half-tab structure. At this time, the risk of causing the bending and the welding processes difficult due to the increase of the number of the electrode tabs of the first electrode tab group for the reason of considering the safety at the same time can be reduced.

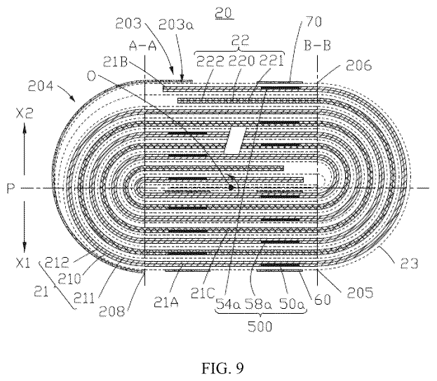

Please refer to FIG. 9. In other examples, the outermost layer of the first electrode tab group 500 is the first electrode tab 50a, the innermost layer is the second electrode tab 54a, and the third electrode tab 58a is sandwiched between the first electrode tab 50a and the second electrode tab 54a. The first area 21A and the second area 21B may also be respectively located at the two sides of the winding central plane P in the first direction X. Therefore, in a case that the first electrode tab 50a and the second electrode tab 54a are respectively located at the outermost layer and the innermost layer of the first electrode tab group 500, it means that all electrode tabs in the first electrode tab group 500 are respectively connected to the first electrode plates 21 located at the two sides of the winding central plane P. At this time, the number of the electrode tabs in the first electrode tab group 500 can be increased according to actual needs, which is conducive to further reducing the internal resistance of the first electrode plate 21 and improving the charge and discharge rate of the electrochemical apparatus 100.

Referring to FIG. 6, the first electrode tab 50 is bent. The first electrode tab 50 includes a first connection area 51 connected to the first area 21A and a second connection area 52 connected to the first connection area 51. The first connection area 51 includes a first end 511 connected to the first area 21A. The first connection area 51 extends from the first end 511 to the first side X1. The first connection area 51 may also extend from the first end 511 to the first surface 111 in the second direction Y, but the first connection area 51 may extend to a position not in contact with the first surface 111. The first connection area 51 is provided obliquely relative to the first direction X. The second connection area 52 includes a second end 521 connected to the first connection area 51. The second connection area 52 extends from the second end 521 to the second side X2. The second connection area 52 may also extend from the second end 521 to the electrode assembly 20, but the second connection area 52 may extend to a position not in contact with the electrode assembly 20. In some examples, the second connection area 52 may also be provided obliquely relative to the first direction X. In the second direction Y, the first connection area 51 extends from the first end 511 beyond the electrode assembly 20, so that the second end 521 is provided apart from the electrode assembly 20.

A directly led-out electrode tab will occupy the space at the head of the electrode assembly, thus reducing the energy density of the electrochemical apparatus. In this application, by bending the first electrode tab 50, it is conducive to reducing the space of the head of the electrode assembly 20 occupied by the first electrode tab 50 in the second direction Y and improving the energy density of the electrochemical apparatus 100. Moreover, since the first connection area 51 of the first electrode tab 50 extends from the first end 511 beyond the electrode assembly 20, the first connection area 51 has a smaller obliquity than the first direction X. The first connection area 51 deviates towards the first side X1 by a larger angle than the first current collector 210 in the first area 21A connected thereto, so that a larger angle between the first connection area 51 and the extended surface of the first current collector 210 when viewed from the third direction Z. Therefore, in a case that the electrode assembly 20 is caused to move in the housing 10 and pull the first electrode tab 50 when mechanical abuse (such as vibration parallel to the first direction X, the second direction Y or the third direction Z) occurs in the electrochemical apparatus 100, the first connection area 51 can provide a larger buffer space, thus reducing the pulling effect of the first electrode tab 50 on the first conductive plate 30, reducing the possibility that the output voltage of the electrochemical apparatus 100 is decreased and even it is impossible to continuously charge and discharge since the first electrode tab 50 and the second electrode tab 54 are separated from the first conductive plate 30, and also reducing the possibility of liquid leakage caused by the first conductive plate 30 being pulled apart from the housing 10. Therefore, this application can improve the reliability and service life of the electrochemical apparatus. In a case that the first electrode tab 50 is located at the outermost layer of the first electrode tab group 500, the first connection area 51 can provide a large buffer space, thus reducing the pulling effect of the first electrode tab 50 on the first conductive plate 30, also reducing the size of the portion of the entire first electrode tab group 500 that goes beyond the electrode assembly 20 from the first side X1, and reducing the influence on the energy density of the electrochemical apparatus 100 in the first direction X. In a case that the second connection area 52 extends from the second end 521 to the electrode assembly 20 and extends to a position not in contact with the electrode assembly 20, it can also reduce the impact of the second connection area 52 on the end of the electrode plate, especially on the extended area 2101 of the first electrode plate 21, when mechanical abuse (such as vibration along the second direction Y) occurs in the electrochemical apparatus 100, thus reducing the possibility of the active material on the electrode plate falling off and causing short-circuiting.

Referring to FIG. 6, in some examples, the second electrode tab 54 is also bent. The second electrode tab 54 includes a third connection area 55 connected to the second area 21B and a fourth connection area 56 connected to the third connection area 55. The third connection area 55 includes a third end 551 connected to the second area 21B. The third connection area 55 extends from the third end 551 to the first side X1. The third connection area 55 also extends from the third end 551 to the first surface 111 in the second direction Y, but the third connection area 55 may extend to a position not in contact with the first surface 111. The third connection area 55 is provided obliquely relative to the first direction X. The fourth connection area 56 includes a fourth end 561 connected to the third connection area 55. The fourth connection area 56 extends from the fourth end 561 to the second side X2. The fourth connection area 56 also extends from the fourth end 561 to the electrode assembly 20, but the fourth connection area 56 may extend to a position not in contact with the electrode assembly 20. In some examples, the fourth connection area 56 may also be provided obliquely relative to the first direction X. The second connection area 52 and the fourth connection area 56 are connected in a stacking manner. The first conductive plate 30 is electrically connected to the second connection area 52 and the fourth connection area 56. In some specific examples, the first conductive plate 30 is connected to the second connection area 52.

Since the third connection area 55 of the second electrode tab 54 is provided obliquely to the first direction X, in a case that the electrode assembly 20 is caused to move in the housing 10 and then pull the second electrode tab 54 when mechanical abuse occurs in the electrochemical apparatus 100, the third connection area 55 can also provide a larger buffer space, thus reducing the pulling effect of the second electrode tab 54 on the first conductive plate 30, reducing the possibility that the output voltage of the electrochemical apparatus 100 is decreased and even it is impossible to continuously charge and discharge since the first electrode tab 50 and the second electrode tab 54 are separated from the first conductive plate 30, and also reducing the possibility of liquid leakage caused by the first conductive plate 30 being pulled apart from the housing 10.

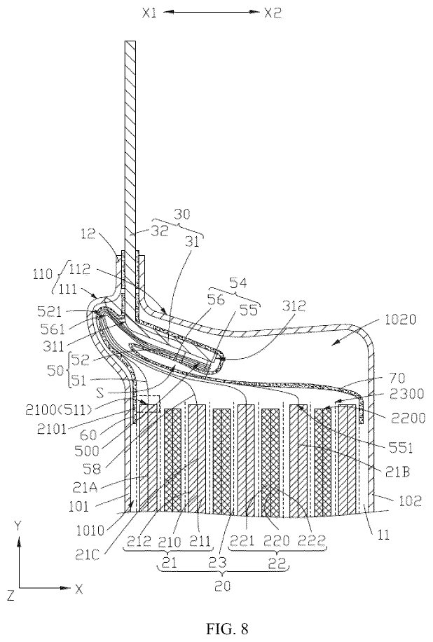

Referring to FIG. 6, in some examples, the first conductive plate 30 is also bent. The first conductive plate 30 includes a first conductive area 31 and a second conductive area 32 connected to each other. The first conductive area 31 is connected to the second connection area 52. When viewed from the first direction X, the first conductive area 31 overlaps the second connection area 52, and the first conductive area 31 overlaps the first connection area 51. The first conductive area 31 includes a fifth end 311 located at the first side X1 and a sixth end 312 located at the second side X2. The fifth end 311 and the sixth end 312 are provided opposite to each other. If a dashed line L1 parallel to the first direction X is drawn through the fifth end 311 and a dashed line L2 parallel to the first direction X is drawn through the sixth end 312, the overlap between the first conductive area 31 and the second connection area 52 is located between the dashed line L1 and the dashed line L2 when viewed from the first direction X. In some examples, in a case that the second connection area 52 is provided obliquely relative to the first direction X, the first conductive area 31 connected to the second connection area 52 is also provided obliquely relative to the first direction X, so that in the second direction Y, the sixth end 312 is closer to the electrode assembly 20 than the fifth end 311. This is conducive to further reducing the space of the head of the electrode assembly 20 occupied by the first electrode tab 50 in the second direction Y, and improving the energy density of the electrochemical apparatus 100. The second conductive area 32 is connected to the fifth end 311 and extends in a direction away from the electrode assembly 20. The second conductive area 32 extends out of the housing 10. For example, the second conductive area 32 may extend out of the housing 10 from the sealing portion 12. In some examples, in a case that the first end surface 110 includes a first surface 111 extending from the sealing portion 12 to the first side X1 and a second surface 112 extending from the sealing portion 12 to the second side X2, when viewed from the second direction Y, the second face 112 overlaps the first conductive area 31. When viewed from the third direction Z, the first conductive area 31 is bent towards a direction close to the first surface 111 relative to the second conductive area 32, so that the first conductive area 31 is closer to the electrode assembly 20 in the second direction Y than the second surface 112. Since the second surface 112 has a larger width in the first direction X than the first surface 111, the space between the second surface 112 and the electrode assembly 20 in the first direction X for accommodating the first conductive area 31 is larger than the space between the first surface 111 and the electrode assembly 20. This is conducive to reducing the possibility of the sixth end 312 puncturing the housing 10 and causing damage and liquid leakage to the housing 10 when mechanical abuse occurs in the electrochemical apparatus 100. It can be understood that since the electrochemical apparatus 100 needs to be vacuumed after formation to exhaust the gas and/or excess electrolyte generated in the formation process, at least a portion of the first surface 111 may be provided in a manner of protruding towards the second connection area 52 after formation, and at least a portion of the second surface 112 may also be provided in a manner of protruding towards the first conductive area 31, so that the first end surface 110 is presented as a non-plane. At this time, it is conducive to further increasing the energy density of the electrochemical apparatus 100. In other examples, the surface on which the first end surface 110 is located may also be a plane extending in the first direction X and the third direction Z. Referring to FIG. 8, in other examples, in a case that the first end surface 110 extends from the sealing portion 12 to the second side X2 (the electrochemical apparatus 100 obtained by encapsulating the housing 10 illustrated in FIG. 4), when viewed from the second direction Y, the first end surface 110 overlaps the first conductive area 31. This can also further increase the width of the space between the first end surface 110 and the electrode assembly 20 for accommodating the first conductive area 31 in the first direction X, and reduce the possibility of the sixth end 312 puncturing the housing 10 and causing damage and liquid leakage to the housing 10.

In some specific examples, the first conductive area 31 is welded to the second connection area 52. During fabrication, the first electrode tab 50 and the second electrode tab 54 may be bent, and the second connection area 52 and the fourth connection area 56 are stacked and welded for fixation; the first conductive plate 30 is bent, and the first conductive area 31 of the bent first conductive plate 30 are stacked on the second connection area 52; then, a welding head is used to weld and fix the first conductive area 31 and the second connection area 52 from one side of the first conductive area 31. At this time, a welding mark between the first conductive area 31 and the second connection area 52 (the welding mark may be produced when the first conductive area 31 is welded to the second connection area 52, which, however, is not limited in this application) will protrude towards the direction of the electrode assembly 20. This is conducive to reducing the possibility of the welding mark puncturing the housing 10 (for example, puncturing the first end surface 110) and causing damage and liquid leakage to the housing 10.

Referring to FIG. 6, in some examples, the second end 521 is located at the first side X1 relative to the fifth end 311, and the second end 521 is provided apart from the fifth end 311. The second end 521 does not go beyond the fifth end 311 from the first side X1. Therefore, referring to FIG. 6, if a dashed line L3 parallel to the second direction Y is drawn through the fifth end 311, there will be a first intersection point 522 between the dashed line L3 and the second connection area 52, and the first intersection point 522 is located at the second side X2 relative to the second end 521. In this way, when mechanical abuse occurs in the electrochemical apparatus 100, when viewed from the third direction Z, the area of the first electrode tab 50 located between the first end 521 and the first intersection point 522 can alleviate the pulling effect on the fifth end 311, thus reducing the possibility that the output voltage of the electrochemical apparatus 100 is decreased and even it is impossible to continuously charge and discharge since the first electrode tab 50 and the second electrode tab 54 are separated from the first conductive plate 30, and also reducing the possibility of liquid leakage caused by the first conductive plate 30 being pulled apart from the housing 10.

Referring to FIG. 6, in some examples, when viewed from the second direction Y, the fifth end 311 overlaps the electrode assembly 20. Therefore, when viewed from the second direction Y, the fifth end 311 does not go beyond the electrode assembly 20. Therefore, when viewed from the second direction Y, a welding area on the first conductive plate 30 does not go beyond the range of the electrode assembly 20. Therefore, when mechanical abuse (such as vibration along the first direction X) occurs in the electrochemical apparatus 100, it can reduce the possibility of the fifth end 311 causing impact on the housing 10, thus reducing the possibility of causing damage and liquid leakage to the housing 10. In some examples, when viewed from the second direction Y, the sixth end 312 overlaps the electrode assembly 20. Therefore, when viewed from the second direction Y, the sixth end 312 does not go beyond the electrode assembly 20. A welding area on the first conductive plate 30 does not go beyond the range of the electrode assembly 20. Therefore, when mechanical abuse (such as vibration along the first direction X) occurs in the electrochemical apparatus 100, it can reduce the possibility of the sixth end 312 causing impact on the housing 10, thus reducing the possibility of causing damage and liquid leakage to the housing 10.

Referring to FIG. 6, in some examples, when viewed from the first direction X, the second end 521 overlaps the second conductive area 32. If a dashed line L4 parallel to the first direction X is drawn through the second end 521, then the dashed line L4 intersects with the second conductive area 32 at a second intersection point 321. When viewed from the first direction X, the fifth end 311 overlaps (that is, intersects at the first intersection point 522) the second connection area 52. In this way, it is conducive to reducing the overall space occupied by the first electrode tab group 500 and the second conductive area 32 in the second direction Y, saving the space of the head of the electrode assembly 20, and thus improving the energy density.

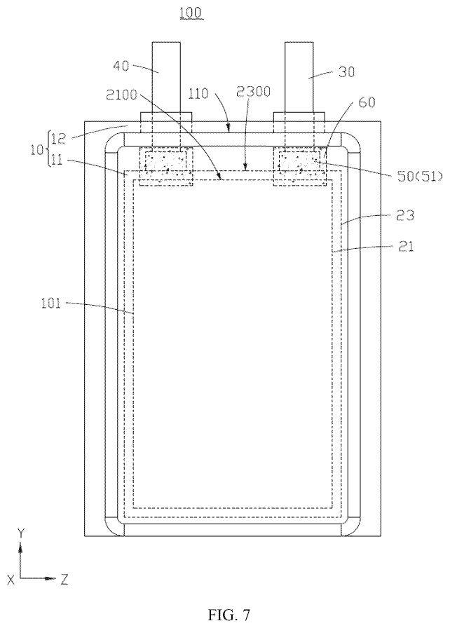

Referring to FIG. 6 and FIG. 7, in some examples, the electrochemical apparatus 100 further includes a first layer 60 with an insulating material. The first layer 60 is located at the first side X1 relative to the first conductive plate 30. The first layer 60 continuously covers a portion of the second conductive area 32, a portion of the second connection area 52 and a portion of the first connection area 51. The first layer 60 is used for covering burrs on the edges of the first conductive plate 30 and the first electrode tab 50 (the burrs may be produced when cutting the first conductive plate 30 and the first electrode tab 50, which, however, is not limited in this application), so as to reduce the possibility of the burrs puncturing the housing 10 and causing damage and liquid leakage to the housing 10. In some examples, the first layer 60 may further cover a portion of the surface of the separator 23 on the outermost layer, so as to improve the bonding stability of the first layer 60. The first layer 60 can be a single-sided adhesive tape or a double-sided adhesive tape containing the insulating material. The insulating material may be at least one selected from the group consisting of polypropylene, polyethylene, polyvinylidene fluoride, vinylidene fluoride-hexafluoropropylene copolymer, polymethyl methacrylate and polyethylene glycol. In other examples, the first layer 60 may also be a ceramic coating layer.

Referring to FIG. 6, further, the electrochemical apparatus 100 further includes a second layer 70 with an insulating material. The second layer 70 is located at the second side X2 relative to the first conductive plate 30. The second layer 70 continuously covers a portion of the second conductive area 32, a portion of the first conductive area 31, a portion of the fourth connection area 56 and a portion of the third connection area 55. The second layer 70 is used for covering burrs on the edges of the first conductive plate 30 and the second electrode tab 54. In addition, the second layer 70 may also cover a welding mark between the first conductive plate 30 and the second electrode tab 54, so as to reduce the possibility of the burrs and welding mark puncturing the housing 10 and causing damage and liquid leakage to the housing 10. Moreover, it can be understood that since the second layer 70 covers the sixth end 312 of the first conductive area 31, it can reduce the impact of the sixth end 312 on the end of the electrode plate, especially on the extended area 2101 of the first electrode plate 21, when mechanical abuse (such as vibration along the first direction X) occurs in the electrochemical apparatus 100, thus reducing the possibility of the active material the electrode plate falling off and causing short-circuiting. In some examples, the second layer 70 may further cover a portion of the surface of the separator 23 on the outermost layer, so as to improve the bonding stability of the second layer 70. The second layer 70 may be a single-sided adhesive tape or a double-sided adhesive tape containing the insulating material. The insulating materials may be at least one selected from the group consisting of polypropylene, polyethylene, polyvinylidene fluoride, vinylidene fluoride-hexafluoropropylene copolymer, polymethyl methacrylate and polyethylene glycol. In other examples, the second layer 70 may also be a ceramic coating layer.

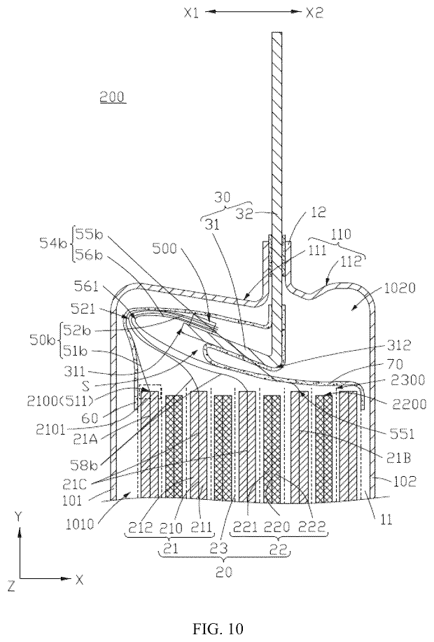

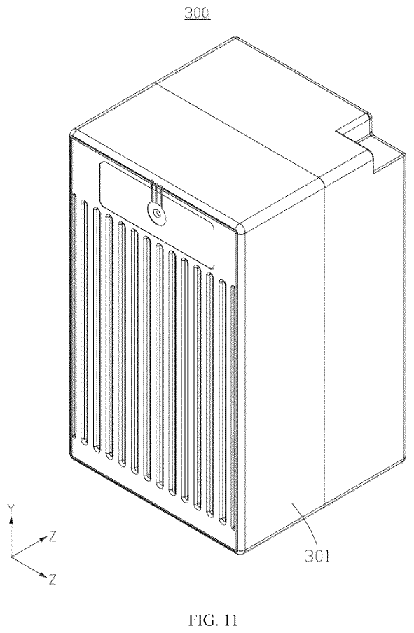

Please refer to FIG. 10. Another example of this application further provides an electrochemical apparatus 200. In this example, a first electrode tab 50b, a second electrode tab 54b and a third electrode tab 58b are stacked and welded together to form a first electrode tab group 500. The first electrode tab 50b may be located at the outermost layer of the first electrode tab group 500. The second electrode tab 54b may be located at the innermost layer of the first electrode tab group 500. The third electrode tab 58b is sandwiched between the first electrode tab 50b and the second electrode tab 54b. The first electrode tab 50b includes a first connection area 51 connected to the first area 21A and a second connection area 52 connected to the first connection area 51. The first connection area 51 includes a first end 511 connected to the first area 21A. The first connection area 51 extends from the first end 511 to the first side X1. The first connection area 51 extends from the first end 511 to the first surface 111 in the second direction Y, but the first connection area 51 may extend to a position not in contact with the first surface 111. The second connection area 52 includes a second end 521 connected to the first connection area 51. The second connection area 52 extends from the second end 521 to the second side X2. The second connection area 52 may also extend from the second end 521 to the electrode assembly 20, but the second connection area 52 may extend to a position not in contact with the electrode assembly 20. In the second direction Y, the first connection area 51 extends beyond the electrode assembly 20 from the first end 511.

The second electrode tab 54b is also bent. The second electrode tab 54b includes a third connection area 55 connected to the second area 21B and a fourth connection area 56 connected to the third connection area 55. The third connection area 55 includes a third end 551 connected to the second area 21B. The third connection area 55 extends from the third end 551 to the first side X1. The third connection area 55 extends from the third end 551 to the first surface 111 in the second direction Y, but the third connection area 55 may extend to a position not in contact with the first surface 111. The fourth connection area 56 includes a fourth end 561 connected to the third connection area 55. The fourth connection area 56 extends from the fourth end 561 to the second side X2. The fourth connection area 56 extends from the fourth end 561 to the electrode assembly 20, but the fourth connection area 56 may extend to a position not in contact with the electrode assembly 20. The second connection area 52 and the fourth connection area 56 are connected in a stacking manner.

The first conductive area 31 of the first conductive plate 30 is connected to the fourth connection area 56. The first conductive area 31 includes a fifth end 311 located at the first side X1 and a sixth end 312 located at the second side X2. The second conductive area 32 is connected to the sixth end 312 and extends in a direction away from the electrode assembly 20. The second conductive area 32 extends out of the housing 10. For example, the second conductive area 32 may extend out of the housing 10 from the sealing portion 12.

Since the second conductive area 32 extends from the sixth end 312, the first conductive plate 30 does not form a tip at the sixth end 312. Compared to the previous example, this application can reduce the impact of the sixth end 312 on the end of the electrode plate, especially on the extended area of the first electrode plate 21, when mechanical abuse occurs in the electrochemical apparatus 100, thus reducing the possibility of the active material on the electrode plate falling off and causing short-circuiting.

In a case that the first layer 60 and the second layer 70 are provided, the first layer 60 continuously covers a portion of the second conductive area 32, a portion of the second connection area 52 and a portion of the first connection area 51, while the second layer 70 continuously covers a portion of the second conductive area 32, a portion of the first conductive area 31 and a portion of the third connection area 55.

The electrochemical apparatuses 100 and 200 in this application include all apparatuses capable of undergoing electrochemical reactions. Specifically, the electrochemical apparatuses 100 and 200 include all kinds of primary batteries, secondary batteries, fuel batteries, solar batteries and capacitors (such as supercapacitors). Optionally, the electrochemical apparatuses 100 and 200 may be lithium secondary batteries, including lithium metal secondary batteries, lithium-ion secondary batteries, lithium polymer secondary batteries, and lithium-ion polymer secondary batteries.

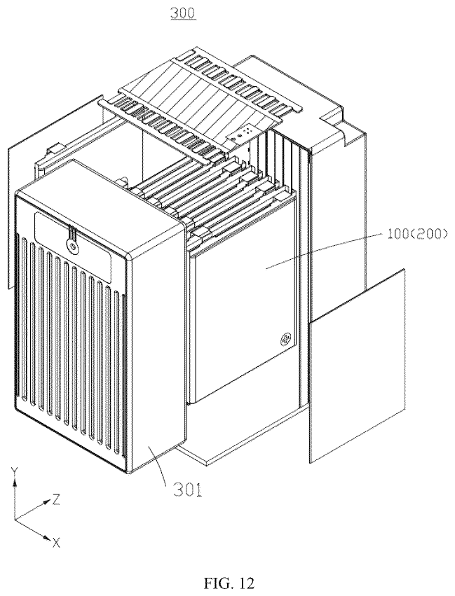

Please refer to FIG. 11 and FIG. 12. An example of this application further provides a module 300, which includes a casing 301 and a plurality of electrochemical apparatuses 100 (or electrochemical apparatuses 200). The plurality of electrochemical apparatuses 100 are located in the casing 301, and the plurality of electrochemical apparatuses 100 are connected in parallel or series. By connecting the plurality of electrochemical apparatuses 100 in parallel or series, the power supply voltage of the module 300 can be increased. In some examples, the plurality of electrochemical apparatuses 100 may be stacked in the first direction X.

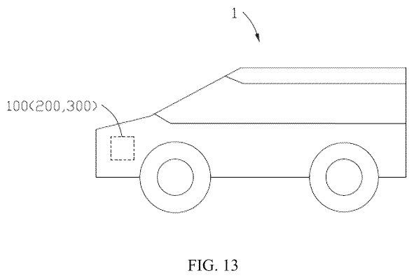

Please refer to FIG. 13. An example of this application further provides an electronic device 1, which includes the electrochemical apparatus 100 (or electrochemical apparatus 200), or includes the module 300. The electronic device 1 is supplied with power by the electrochemical apparatus 100, and has improved reliability and service life. In an example, the electronic device 1 in this application may include, but not limited to, laptop computers, stylus input computers, mobile computers, e-book players, portable phones, portable fax machines, portable copiers, portable printers, head-mounted stereo earphones, video recorders, LCD TVs, portable cleaners, portable CD layers, mini CD layers, transceivers, electronic notepads, calculators, memory cards, portable audio recorders, radio sets, backup power supplies, motors, cars, motorcycles, power bicycles, bicycles, lighting fixtures, toys, game consoles, clocks, electric tools, flash lights, cameras, large household batteries, and lithium-ion capacitors.

This application will be described below in detail through specific examples and comparative examples. Taking the electrochemical apparatus 100 being a flexible battery, the first electrode plate 21 being a positive electrode and the first conductive plate 30 being a positive electrode conductive plate as an example, in combination with specific testing methods, this application will be described. Those skilled in the art should understand that the preparation method described in this application is only an example, and any other suitable preparation method is included in the scope of this application.

### Example

Preparation of first electrode plate 21: a positive electrode active material LiMnO₂, conductive carbon black (Super P), carbon nanotubes and polyvinylidene fluoride (PVDF) were mixed according to a weight ratio of 96:1.4:0.6:2. N-methylpyrrolidone (NMP) was added as a solvent to prepare slurry with a solid content of 75 wt %. Uniform mixing was performed. The slurry was uniformly coated to one surface of an aluminum foil with a thickness of 12 μm. Drying was performed at 90° ° C. to obtain a first active material layer 211 with a thickness of 100 μm. The above steps were repeated on the other surface of the aluminum foil to obtain a second active material layer 212 with a thickness of 100 μm. Then, processes of cold pressing and slicing (cutting the electrode plate into the required size) were performed to obtain a first electrode plate 21 with a size of 2837 mm*160 mm. A first electrode tab 50 and a second electrode tab 54 connected to the first electrode plate 21 were bent and welded for fixation. Then, a first conductive plate 30 was welded to a second connection area 52 of the bent first electrode tab 50.

Preparation of second electrode plate 22: a negative electrode active material graphene, styrene-butadiene (SBR) and carboxymethyl cellulose (CMC) were mixed according to a weight ratio of 97:2:1. Deionized water was added as a solvent to prepare slurry with a content of 70 wt %. Uniform mixing was performed. The slurry was uniformly coated to one surface of a copper foil with a thickness of 10 μm. Drying was performed at 110° C. to obtain a third active material layer 221 with thickness of 150 μm. The above steps were repeated on the other surface of the copper foil to obtain a fourth active material layer 222 with a thickness of 150 μm. Then, processes of cold pressing and slicing were performed to obtain a second electrode plate 22 with a size of 2550 mm*156 mm. A plurality of lugs connected to the first electrode plate 21 were bent and welded for fixation. Then, a similar method was used to weld a second conductive plate 40 to the bent lugs.

Preparation of electrolyte: in dry argon atmosphere, firstly organic solvents ethylene carbonate (EC) and diethyl carbonate (DEC) were mixed according to a mass ratio of 1:1. Then, fluoroethylene carbonate (FEC) with a mass fraction of 5%, 1,3-propane sulfonate lactone (PS) with a mass fraction of 5% and lithium salt lithium hexafluorophosphate (LiPF₆) were added to the organic solvents, dissolved and mixed uniformly to obtain an electrolyte with a lithium salt concentration of 1 mol/L.

Preparation of battery: referring to FIG. 2A and FIG. 6, the first electrode plate 21, a separator 23 and the second electrode plate 22 were sequentially stacked and wound to obtain an electrode assembly 20. The separator 23 was a polyethylene (PE) film with a thickness of 1.5 μm. Then, liquid injection, formation and encapsulation were performed to obtain a battery with a size of 175 mm*143 mm*10.3 mm, a platform voltage of 2.8-4.2V and a capacity of 24 Ah. In the second direction Y, the first connection area 51 extended beyond the electrode assembly 20 from a first end 511, so that a second end 521 was provided apart from the electrode assembly 20.

Preparation of module: 13 batteries were connected in series and placed into a casing to obtain a module with a size of 184 mm*156 mm*264 mm, a platform voltage of 48V and a capacity of 24 Ah.

A difference of Comparative Example from Example above was that in a single battery produced, in the second direction Y, the first connection area 51 did not go beyond the electrode assembly 20. Therefore, when viewed from the second direction Y, the second end 521 overlapped the electrode assembly 20.

10 modules were taken from each of Example and Comparative Example for vibration testing. The vibration testing included the following specific steps: 1) the voltage and internal resistance of the modules were measured, the charge and discharge sampling frequency was Is, and the time of keeping them stationary was 1 min; 2) charging to 54.2V was performed at a constant current of 4 A under an environmental condition of 25±5° C., and then charging was performed at a constant voltage until the current dropped to 0.6 A; 3) the voltage and internal resistance of the modules were measured; 4) the modules were mounted on a vibrating platform by using pressure strips, logarithmic scanning was performed with sine waves at frequency between 7 Hz and 200 Hz, then the frequency was returned to frequency of 7 Hz within 15 min, the vibration was carried out respectively along the second direction Y, the third direction Z and the first direction X, the vibration in each direction was cycled for 12 times and the total vibration time was 3 h; the logarithmic scan maintained a peak acceleration of 1 gn from 7 Hz until reaching 18 Hz, then the amplitude remained at 0.8 mm (with a total offset of 1.6 mm), and the frequency continuously increased until reaching peak acceleration of 8 gn (approximately 50 Hz); then a peak acceleration of 8 gn was maintained until the frequency reached 200 Hz; 5) the voltage and internal resistance of the modules were measured; 6) discharging to 39V was performed at a constant current of 15 A, and then they were kept stationary for 2 h; 7) charging to 54.2V was performed at a constant current of 4 A, then charging was performed at a constant voltage until the current dropped to 0.6 A; 7) in a case that no failure (such as liquid leakage, gas leakage or fire) occurred in a module during or after the testing process and the open circuit voltage of the module was not less than 90% of the voltage before the testing, it was determined that it passed the test. The testing results are recorded in Table 1.

TABLE 1

| | Test pass rate |
|---|---|
| Example | 10/10 |
| Comparative | 3/10 |
| Example | |

Note:
the test pass rate X/10 indicates that X samples of 10 samples tested have passed the test.

From the data in Table 1, it can be seen that since the first connection area extends beyond the electrode assembly from the first end in the example, in the vibration testing process, the first connection area can provide a large buffer space and reduce the pulling effect of the first electrode tab on the first conductive plate. Therefore, the modules in the example have a high test pass rate.

What are disclosed above are only preferred examples of this application, which, however, are not intended to limit this application. Therefore, all equivalent changes made according to this application still fall within the scope of this application.

What is claimed is:

1. An electrochemical apparatus, comprising: a housing, an electrode assembly disposed in the housing, and a first conductive plate; the electrode assembly comprising a first electrode plate, the first electrode plate comprising a first area and a second area stacked in a first direction; wherein
the electrochemical apparatus further comprises a first electrode tab connected to the first area and a second electrode tab connected to the second area, the first conductive plate is electrically connected to the first electrode tab and the second electrode tab, and the first conductive plate protrudes from the housing;
the first electrode tab comprises a first connection area and a second connection area, the first connection area comprises a first end connected to the first area, the first direction has a first side from the second area to the first area and a second side from the first area to the second area, the first connection area extends from the first end to the first side, the first connection area is provided obliquely relative to the first direction, the second connection area comprises a second end connected to the first connection area, and the second connection area extends from the second end to the second side;
in a second direction perpendicular to the first direction, the second end is provided apart from the electrode assembly.

2. The electrochemical apparatus according to claim 1, wherein the second electrode tab comprises a third connection area and a fourth connection area, the third connection area comprises a third end connected to the second area, the third connection area extends from the third end to the first side, the third connection area is provided obliquely relative to the first direction, the fourth connection area comprises a fourth end connected to the third connection area, the fourth connection area extends from the fourth end to the second side, and the second connection area and the fourth connection area are connected in a stacking manner.

3. The electrochemical apparatus according to claim 2, wherein at least the first electrode tab and the second electrode tab are welded to form a first electrode tab group, and the first electrode tab is located at an outermost layer of the first electrode tab group.

4. The electrochemical apparatus according to claim 3, wherein the second electrode tab is located at an innermost layer of the first electrode tab group.

5. The electrochemical apparatus according to claim 3, wherein the first conductive plate comprises a first conductive area and a second conductive area connected to each other, the first conductive area is connected to the second connection area, the first conductive area comprises a fifth end located at the first side and a sixth end located at the second side, the second conductive area is connected to the fifth end and extends in a direction away from the electrode assembly, and the second conductive area protrudes from the inside of the housing.

6. The electrochemical apparatus according to claim 3, wherein the first conductive plate comprises a first conductive area and a second conductive area connected to each other, the first conductive area is connected to the fourth connection area, the first conductive area comprises a fifth end located at the first side and a sixth end located at the second side, the second conductive area is connected to the sixth end and extends in a direction away from the electrode assembly, and the second conductive area protrudes from the inside of the housing.

7. The electrochemical apparatus according to claim 5, wherein the second end is located at the first side relative to the fifth end.

8. The electrochemical apparatus according to claim 7, wherein viewed from the second direction, the fifth end overlaps the electrode assembly.

9. The electrochemical apparatus according to claim 5, wherein viewed from the second direction, the sixth end overlaps the electrode assembly.

10. The electrochemical apparatus according to claim 5, wherein viewed from the first direction, the second end overlaps the second conductive area and the fifth end overlaps the second connection area.

11. The electrochemical apparatus according to claim 5, wherein the second connection area and the first conductive area are provided obliquely relative to the first direction; and in the second direction, the sixth end is closer to the electrode assembly than the fifth end.

12. The electrochemical apparatus according to claim 5, wherein the electrochemical apparatus further comprises a first layer with an insulating material; and the first layer continuously covers a portion of the second conductive area, a portion of the second connection area and a portion of the first connection area.

13. The electrochemical apparatus according to claim 5, wherein the electrochemical apparatus further comprises a second layer with an insulating material, and the second layer continuously covers a portion of the second conductive area, a portion of the first conductive area, a portion of the fourth connection area and a portion of the third connection area.

14. The electrochemical apparatus according to claim 4, wherein the electrode assembly further comprises a second electrode plate and a separator; and the first electrode plate, the separator and the second electrode plate are sequentially stacked and wound to form the electrode assembly.

15. The electrochemical apparatus according to claim 14, wherein the electrode assembly has a winding central axis, a plane passing through the winding central axis and perpendicular to the first direction is a winding central plane, and the first area and the second area are respectively located at two sides of the winding central plane.

16. The electrochemical apparatus according to claim 14, wherein the electrode assembly has a winding central axis, a plane passing through the winding central axis and perpendicular to the first direction is a winding central plane, and the first area and the second area are located at the same side of the winding central plane.

17. The electrochemical apparatus according to claim 14, wherein the separator is located on at least a portion of the outermost layer of the electrode assembly.

18. The electrochemical apparatus according to claim 5, wherein the housing comprises a main body for accommodating the electrode assembly and a sealing portion connected to the main body, and the first conductive plate extends from the sealing portion to the housing; the main body comprises a first end surface connected to the sealing portion, the first end surface comprises a first surface extending from the sealing portion to the first side and a second surface extending from the sealing portion to the second side; in the first direction, a width of the first surface is less than a width of the second surface; and viewed from the second direction, the second surface overlaps the first conductive area.

19. The electrochemical apparatus according to claim 5, wherein the housing comprises a main body for accommodating the electrode assembly and a sealing portion connected to the main body, and the first conductive plate extends from the sealing portion to the housing; the main body comprises a first end surface connected to the sealing portion, and the first end surface extends from the sealing portion to the second side; and viewed from the second direction, the first end surface overlaps the first conductive area.

20. The electrochemical apparatus according to claim 18, wherein the housing comprises a first housing and a second housing provided opposite to each other in the first direction, the first housing comprises a first polymer layer, the second housing comprises a second polymer layer, and the first polymer layer and the second polymer layer are bonded to each other to form the sealing portion.

21. The electrochemical apparatus according to claim 1, wherein the first conductive plate is welded to the first electrode tab or the second electrode tab.

22. An electronic device, comprising an electrochemical apparatus; wherein the electrochemical apparatus comprises a housing, an electrode assembly provided in the housing, and a first conductive plate; the electrode assembly comprising a first electrode plate, the first electrode plate comprising a first area and a second area stacked in a first direction; wherein
the electrochemical apparatus further comprises a first electrode tab connected to the first area and a second electrode tab connected to the second area, the first conductive plate is electrically connected to the first electrode tab and the second electrode tab, and the first conductive plate protrudes from the housing;
the first electrode tab comprises a first connection area and a second connection area, the first connection area comprises a first end connected to the first area, the first direction has a first side from the second area to the first area and a second side from the first area to the second area, the first connection area extends from the first end to the first side, the first connection area is provided obliquely relative to the first direction, the second connection area comprises a second end connected to the first connection area, and the second connection area extends from the second end to the second side;
in a second direction perpendicular to the first direction, the second end is provided apart from the electrode assembly.
